(19) United States
(12) Patent Application Publication
(10) Pub. No.: US 2014/0259592 A1
(43) Pub. Date: Sep. 18, 2014

(54) TOOL AND METHOD FOR REMOVING DRAW WEDGE BOLTS DURING KINGPIN REPLACEMENT

(71) Applicants: Derek F. Stephens, Mustang, OK (US); Aaron Willis, Edmond, OK (US); Sean D. Stephens, San Diego, CA (US)

(72) Inventors: Derek F. Stephens, Mustang, OK (US); Aaron Willis, Edmond, OK (US); Sean D. Stephens, San Diego, CA (US)

(21) Appl. No.: 13/840,608

(22) Filed: Mar. 15, 2013

(51) Int. Cl. B25B 19/00; B25B 27/02

(52) U.S. Cl. CPC B25B 19/00; B25B 27/02
USPC 29/402.08; 29/277; 29/426.5

(57) ABSTRACT

A tool and method for removing draw wedge bolt during replacement of the kingpin of a steering system assembly is disclosed. The tool is adapted to attach to the threaded end of a draw wedge bolt of a steering system assembly. After the tool is attached, sufficient force can be applied to the impact end of the tool using a manual or pneumatic hammer without damaging the draw wedge bolt. The tool also provides an adapter which allows the tool to affix to various sized draw wedge bolts from different vehicle manufacturers. The impact end of the tool is also keyed to be able to be turned by a wrench of a socket. This tool and method allow for faster and easier removal of the draw wedge bolts than previous methods.

### 1.0 FIELD OF THE INVENTION

The present disclosure relates generally to hand tools. More particularly, this disclosure relates to tools and methods to remove draw wedge bolts in order to remove and replace the kingpin in a vehicle steering assembly.

### 2.0 BACKGROUND OF THE INVENTION

In a steering assembly of large vehicles such as semi-trailer trucks draw wedge bolts are placed horizontally into cavities of the vehicle steering assembly to secure a vertically placed kingpin. When the kingpin becomes worn or damaged, it must be replaced. To service the kingpin draw wedge bolts must be removed to retrieve the kingpin.

Typical removal methods include either use of hand-hammer or pneumatic hammer applied directly onto draw wedge bolt or use of cutting torch to cut out the draw wedge. During the first removal method, if the hammer is not struck directly onto the small diameter of the draw wedge bolt, the draw wedge bolt may bend and cannot then be extracted. Using the second removal method requires heating areas near the steering assembly and slag must be cleaned from cavity for replacement of new draw wedge bolt and kingpin. The immense heat can also cause unintended damage to the vehicle. For example, rubber hosing and bushings that may be present near the kingpin may be inadvertently melted or compromised from the heat. Either method described is time consuming and may add several hours to the maintenance of the vehicle.

What is required is a tool and method for easy, efficient, time saving way to remove the draw wedge bolts and to enable a mechanic to quickly and easily access the kingpin for maintenance of the steering assembly of a vehicle.

### 3.0 SUMMARY OF INVENTION

The present application discloses a draw wedge bolt removal tool comprising a single unit impact tool for assisting in the removal of draw wedge bolts that hold a kingpin in place on vehicle steering assemblies. The draw wedge bolt removal tool consists of a threaded smaller diameter end that meets the pitch and diameter of the draw wedge bolt with a clearance length tapered to a larger diameter impact end that will receive the force from a hand or pneumatic hammer to remove the tightened draw wedge bolt. The impact end of the removal tool comprises an inlet hole for insertion of the bolt of the pneumatic hammer. After sufficient impact force is applied to the impact end of the tool the draw wedge bolt will become loosened. Once the draw wedge bolt is loosened, the draw wedge removal tool is unthreaded. In case of a non-threaded draw wedge bolt, the draw wedge bolt removal tool slides over the diameter of draw wedge bolt, impact is made, and the draw wedge removal tool is removed.

Other systems, methods, features and advantages of the invention will be or will become apparent to one with skill in the art upon examination of the following figures and detailed description. It is intended that all such additional systems, methods, features and advantages be included within this description, be within the scope of the invention.

### 4.0 BRIEF DESCRIPTION OF THE FIGURES

The forgoing and other aspects, objects, features and advantages of the apparatus and method disclosed will become better understood with reference to the following description, claims, and accompanying drawings, where:

FIG. 1 is the top-front perspective view of the draw wedge removal tool.

FIG. 2 is the rear-bottom perspective view of the tool.

FIG. 3 is the side view of the tool.

FIG. 4 is the top view of the tool.

FIG. 5 is the bottom view of the tool.

FIG. 6 is a section view showing the depth of the holes in the top and bottom of the tool.

FIG. 7 is a perspective view of the tool with an adapter.

FIG. 8 is a contextual view showing the location of the kingpin and the draw wedge bolts in a steering assembly.

FIG. 9 is a more simplified and exploded contextual view showing the location of the kingpin and the draw wedge bolts.

FIG. 10 illustrates the use of the tool for removing the draw wedge bolts.

FIG. 11 illustrates the attachment of the tool to the draw wedge bolts.

FIG. 12 shows the use of the tool for loosening the draw wedge bolts.

FIG. 13 illustrates the tool unattached from the draw wedge bolt and the draw wedge bolt being freed.

### 5.0 DETAILED DESCRIPTION

FIGS. 1-6 depicts the draw wedge bolt removal tool 100 disclosed in the present application. The draw wedge bolt removal tool 100 is comprised of a cylindrical structure comprising two ends: an impact end 105 opposite a threaded end 110. The impact end 105 comprises a substantially flat surface with a cavity 115 in the center of the surface. The cavity 115 is adapted to receive an impact bolt of a pneumatic hammer without the bolt exiting the cavity. The threaded end 110 of the draw wedge bolt removal tool comprises a cavity 120 that is internally threaded to screw onto the threaded bolt of a steering system draw wedge bolt.

The impact end 105 may comprise an outside edge 125 that is keyed or adapted to be turned by a wrench or a socket. This feature assists the mechanic in affixing and removing the draw wedge bolt removal tool 100 from the draw wedge bolt.

This tool may be part of a kit. The tool kit includes adaptors 705 which affix to the threaded end of the draw wedge tool 100 in order to accommodate different sized draw wedge bolts 810. While several different vehicle manufacturers use roughly the same draw wedge design to hold in the kingpin 805, the various manufacturers use different sized draw wedge bolts 810 with different thread pitches. This kit provides the mechanic different sized adapters 705 to screw onto the threaded end of the tool to accommodate the standard sized draw wedge bolts 810 for different steering system assemblies. Another way to accommodate different sized draw wedge bolts is to have the diameter of the threaded end 110 of the tool large enough to accommodate all the various sizes of draw wedge bolts 810. Thread inserts can be inserted into the cavity 120 of the threaded end 110 to accommodate the varying sizes of the draw wedge bolts 810.

The tool 100 may be tapered so a diameter of the structure is largest at the impact end 105 and decreases to the threaded end 110. The tapering provides for both a more natural hand grip for the mechanic on the tool 100 and provides for a larger surface area on the impact end 105 to strike. In addition it provides a narrower end at the threaded end 110 which may be beneficial when performing maintenance in the tight area of the steering wheel assembly.

The tool 100 can be constructed of various types of materials including high strength metal alloys. Preferably, the tool 100 is constructed of tool steel which refers to a variety of carbon and alloy steels that are particularly well-suited to be made into tools. Their suitability comes from their distinctive hardness, resistance to abrasion, their ability to hold a cutting edge, and/or their resistance to deformation at elevated temperatures (red-hardness). Tool steel is generally used in a heat-treated state. Many high carbon tool steels are also more resistant to corrosion due to their higher ratios of elements such as vanadium and niobium. With a carbon content between 0.7% and 1.5%, tool steels are manufactured under carefully controlled conditions to produce the required quality. The manganese content is often kept low to minimize the possibility of cracking during water quenching. However, proper heat treating of these steels is important for adequate performance, and there are many suppliers who provide tooling blanks intended for oil quenching.

Tool steels are made to a number of grades for different applications. Choice of grade depends on, among other things, whether a keen cutting edge is necessary, as in stamping dies, or whether the tool has to withstand impact loading and service conditions encountered with such hand tools as axes, pickaxes, and quarrying implements. In general, the edge temperature under expected use is an important determinant of both composition and required heat treatment. The higher carbon grades are typically used for such applications as stamping dies, metal cutting tools, etc.

In one embodiment, the tool 100 is comprised of shock resisting type steel. S-type tool steel is designed to resist shock at both low and high temperatures. A low carbon content is required for the necessary toughness (approximately 0.5% carbon). Carbide-forming alloys provide the necessary abrasion resistance, hardenability, and hot-working characteristics. This family of steels displays very high impact toughness and relatively low abrasion resistance, it can attain relatively high hardness (HRC 58/60).

FIG. 8 illustrates the steering assembly of a vehicle with the kingpin 805 being held in place by two draw wedge bolts 810. FIG. 9 is a simplified and exploded view of the steering assembly. When the draw wedge bolts 810 are inserted into the assembly and as they are tightened using nuts 905, the draw wedge bolts 810 are drawn further into the assembly causing the draw wedge bolts 810 to exert a greater force on the kingpin 805. In this manner, the kingpin 805 snuggly fits into the steering assembly.

FIGS. 10-13 depict a method to remove a draw wedge bolts to facilitate removal and replacement of the kingpin 805 for a steering wheel assembly. The method begins with selecting the draw wedge bolt removal tool 100 with a threaded end 110 sized to affix to the draw wedge bolt 810 (as shown in FIG. 1) or selecting the draw wedge bolt removal tool 100 with an adaptor 705 sixed to fit the draw wedge bolt 810. Next a mechanic unscrews and removes the nut 905 from the draw wedge bolt 810. As shown in FIG. 11, the mechanic then screws the draw wedge bolt removal tool 100 onto the draw wedge bolt 810. Using the novel keyed 125 impact end 105 of the draw wedge bolt removal tool 100, the mechanic can use a wrench or socket to affix the tool to the bolt 810. At FIG. 12, the mechanic supplies sufficient force to the impact end 105 of the draw wedge removal tool to loosen the bolt from the kingpin. A mechanic may use a conventional hammer to apply the impact force or a pneumatic hammer. One feature of the tool is that the impact end has a cavity 115 in the center to receive the impact bolt of the pneumatic hammer. The cavity in the impact end 115 is designed so that the bolt of the hammer will not travel outside the cavity and will not endanger the mechanic. After force is applied, the draw wedge bolt should come loose from the kingpin 805, as shown in FIG. 13.

After the draw wedge bolt is loosened, the mechanic will remove the draw wedge bolt removal tool 100 from the draw wedge bolt 810. Next, the mechanic will remove the draw wedge bolt from the steering assembly. Following removal, the mechanic will remove and replace the kingpin 805 as necessary. Following installation of the kingpin 805, the mechanic will reinstall the draw wedge bolts into the steering assembly cavity and reinstall the nut 905 onto the draw wedge bolt 810. The mechanic will tighten the nut 905 to the manufacturer recommended torque.

While the description above refers to particular embodiments of the present invention, it should be readily apparent to people of ordinary skill in the art that a number of modifications may be made without departing from the spirit thereof. The accompanying claims are intended to cover such modifications as would fall within the true spirit and scope of the invention. The presently disclosed embodiments are, therefore, to be considered in all respects as illustrative and not restrictive, the scope of the invention being indicated by the appended claims rather than the foregoing description. All changes that come within the meaning of and range of equivalency of the claims are intended to be embraced therein. Moreover, the applicants expressly do not intend that the following claims “and the embodiments in the specification to be strictly coextensive.” Phillips v. AHW Corp., 415 F.3d 1303, 1323 (Fed. Cir. 2005) (en banc).

1. A draw wedge bolt removal tool, comprising:
a structure comprising an impact end opposite a threaded end;
the impact end comprising a substantially flat surface with a cavity in the center of the surface, the cavity being adapted to receive a impact bolt of a pneumatic hammer and sized so as to prevent the bolt from traveling outside of the cavity during operation of the pneumatic hammer; and
the threaded end comprising a cavity that is internally threaded to attach the structure to a threaded portion of a draw wedge bolt.

2. The apparatus of claim 1, wherein the impact end comprises an outside edge, the outside edge being keyed or adapted to be turned by a wrench or a socket.

3. The apparatus of claim 1, further comprising a plurality of adaptors which affix to the threaded end of the tool in order to accommodate different sized draw wedge bolts.

4. The apparatus of claim 1, wherein the threaded end comprises a plurality of threads to accommodate different sized draw wedge bolts.

5. The apparatus of claim 1, wherein the structure is cylindrical and tapered so a diameter of the structure is largest at the impact end and decreases from the impact end to the threaded end.

6. The apparatus of claim 1, wherein the structure is comprised of a high strength metal alloy.

7. The method of removing a draw wedge bolt installed in a steering assembly, the assembly comprising a kingpin and the draw wedge bolt comprising a threaded portion, the method comprising:
identifying the size and thread pitch of the threaded portion of the draw wedge bolt;
selecting a tool that is compatible with the size and thread pitch of the threaded portion of the draw wedge bolt, wherein the tool further comprises:
a structure comprising an impact end opposite a threaded end, the impact end comprising a flat surface with a cavity in the center of the surface, the cavity being adapted to receive a impact bolt of a pneumatic hammer and sized so as to prevent the bolt from traveling outside of the cavity during operation of the pneumatic hammer, the threaded end comprising a cavity that is internally threaded;
removing a nut from the threaded portion of the draw wedge bolt;
screwing the tool onto the threaded portion of the draw wedge bolt;
applying impact force to the impact end of the tool;
continuing to apply impact force until the draw wedge breaks free from the kingpin;
unscrewing and removing the tool from the threaded portion of the draw wedge bolt; and
removing the draw wedge from the steering assembly.

8. The method of claim 7, further comprising:
removing and replacing the kingpin;
reinstalling the draw wedge bolt into the steering assembly;
reinstalling the nut to the draw wedge bolt; and
tightening the nut to specified torque.

9. The method of claim 7, further comprising:
selecting an adaptor comprising two threaded ends;
threading one end of the adaptor to the threaded end of the tool; and
threading the other end of the adaptor to the threaded portion of the draw wedge bolt.

10. The method of claim 7, further comprising:
using a manual hammer to provide the impact force to the impact end of the tool.

11. The method of claim 7, further comprising:
using a pneumatic hammer to provide the impact force to the impact end of the tool.

12. The method of claim 7, further comprising:
using a wrench or socket to screw the threaded end of the tool onto the threaded portion of the draw wedge bolt.
